(19) United States
(12) Patent Application Publication
(10) Pub. No.: US 2012/0026474 A1
(43) Pub. Date: Feb. 2, 2012

(54) Reticle Cooling in a Lithographic Apparatus

(75) Inventor: Samir A. NAYFEH, Shrewsbury, MA (US)

(73) Assignee: ASML HOLDING N.V., Veldhoven (NL)

(21) Appl. No.: 13/097,781

(22) Filed: Apr. 29, 2011

Related U.S. Application Data
(60) Provisional application No. 61/369,960, filed on Aug. 2, 2010.

(51) Int. Cl. G03B 27/62

(52) U.S. Cl. 355/30; 355/75; 355/77

(57) ABSTRACT

An apparatus and method reduce temperature variation across a reticle so as to reduce the expansion variation of the reticle. One method for realizing reduced temperature variation is to fill an inner space with backfill gas under pressure, using distribution trenches and walls (e.g., flow restriction dams), rather than providing uniform backfill gas pressure across the entire reticle. In another method, the perimeter of inner space can be chosen to reduce the expansion variation across the reticle based on the functional relationship between expansion and temperature for the reticle material. In an optional or alternative approach, reduced temperature variation across the reticle can be obtained by selectively filling cavities in the interior of the fluid cooled chuck with backfill gas.

### CROSS REFERENCE TO RELATED APPLICATIONS

This application claims priority under 35 U.S.C. 119(e) to U.S. Provisional Patent Application No. 61/369,960, filed Aug. 2, 2010, which is incorporated by reference herein in its entirety.

### BACKGROUND

1. Field

The present invention relates to a cooling apparatus, and in particular to a reticle cooling apparatus for use in lithographic applications.

2. Background Art

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g., including part of, one, or several dies) on a substrate (e.g., a silicon wafer). Transfer of the pattern is typically via imaging onto a layer of radiation-sensitive material (resist) provided on the substrate. In general, a single substrate will contain a network of adjacent target portions that are successively patterned. Known lithographic apparatus include so-called steppers, in which each target portion is irradiated by exposing an entire pattern onto the target portion at one time, and so-called scanners, in which each target portion is irradiated by scanning the pattern through a radiation beam in a given direction (the “scanning”-direction, also referred to as the “y-direction”) while synchronously scanning the substrate parallel or anti-parallel to this direction. It is also possible to transfer the pattern from the patterning device to the substrate by imprinting the pattern onto the substrate.

Modern day semiconductor lithography requires extremely tight tolerances in order to ensure that highly accurate patterns are transposed to the substrate. Some reticles (e.g., extreme ultra-violet (EUV) reticles) operate by reflection of the incident radiation, with the reflected radiation being the desired patterned beam of radiation. However, not all of the incident radiation is reflected; some of the radiation is absorbed by the reticle. Reticle heating causes thermal gradients in the reticle material, which result in deformations that in turn appear as image placement errors. For purposes of illustration, the center of the reticle can become relatively hot, while the edges of the reticle can become relatively cool, causing a non-uniform expansion of the reticle.

Thus, because of the heat absorption, the patterned beam of radiation from the heated reticle becomes distorted, which results in a significant error and a resulting impediment to the faithful reproduction of the small circuit features. Alternatives to reducing reticle heating errors include changing reticle material and lowering the cooling water temperature of the chuck/clamp. However, these alternatives do not change the nature of the shape of the reticle of the temperature gradients across the surface of the reticle; instead, they reduce the gradient through the thickness of the reticle.

### BRIEF SUMMARY

What is needed is a means by which the heat-related distortion and its impact on the fabrication of the small circuit feature dimensions can be reduced. In particular, what is needed is an apparatus and method to reduce the temperature variation across the reticle and to thereby reduce the resulting pattern distortion.

In one embodiment of the present invention, the temperature variation can be reduced by varying the thermal conduction between the backside of the reticle and the front side of the chuck. In an exemplary embodiment, such variation can be achieved by changing the perimeter of a wall (e.g., flow restriction dam). Thus, the perimeter of the wall is designed to reduce the thermal conduction at the edges of the reticle while maintaining the thermal conduction at the center of the reticle. By doing so, the temperature variation across the reticle, and the resulting expansion, becomes more uniform.

In a further exemplary embodiment, the relationship between expansion and temperature of the reticle material is exploited. Rather than the design goal be to reduce the temperature variation across the reticle by a particular perimeter of a wall (e.g., flow restriction dam), an alternative design goal is to select a non-uniform thermal conduction profile that, when combined with the relevant material expansion-temperature characteristic, a reduced expansion variation across the reticle results. In a particular embodiment, the temperature variation of the reticle can be centered on a minimum of the material expansion-temperature characteristic so that the resulting expansion variation across the reticle is thereby minimized

In a still further embodiment of the present invention, selectively fillable cavities in the chuck can be used to produce a variable thermal conduction profile across the reticle. Selectively fillable cavities are positioned between the protrusions and cooling channels of the chuck. Selectively fillable cavities function by each being selectively fillable by a backfill gas. By selectively filling the cavities with thermally conducting backfill gas, the thermal conduction path from the heat originating in the reticle to the cooling channels can be modulated in accordance with a particular design goal. In particular, the modulation of the thermal conduction paths can result in a reduction in the temperature variation across the reticle and its resulting expansion profile.

Further embodiments, features, and advantages of the invention, as well as the structure and operation of the various embodiments of the invention are described in detail below with reference to the accompanying drawings.

### BRIEF DESCRIPTION OF THE DRAWINGS/FIGURES

Embodiments of the present invention are described with reference to the accompanying drawings. In the drawings, like reference numbers indicate identical or functionally similar elements.

FIGS. 1A and 1B respectively depict reflective and transmissive lithographic apparatuses.

FIG. 2 is a diagram of a reticle illuminated by incident radiation.

FIG. 3 is a diagram of a reticle positioned by a chuck.

FIG. 4 is a diagram of a plan view of a distribution trench and feedpoints for provision of backfill gas to a reticle positioned by a chuck.

FIG. 5 is a diagram of a cross-sectional view of a distribution trench and wall (e.g., flow restriction dam) configuration for distributing backfill gas for heat transfer between a reticle and a chuck.

FIGS. 6A and 6B illustrate a plan view and a perspective view of a wall (e.g., flow restriction dam) configuration to reduce the reticle temperature variation, according to an embodiment of the current invention.

FIG. 7 is a diagram of an exemplary expansion versus temperature relationship for a reticle material.

FIG. 8 illustrates a cross-sectional view of the use of selectively fillable cavities to reduce the reticle temperature variation, according to an embodiment of the current invention.

FIG. 9 provides a flowchart of a method that determines a shape of a wall (e.g., flow restriction dam) for distributing backfill gas for heat transfer between a reticle and a chuck, according to an embodiment of the current invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

Before describing such embodiments in more detail, however, it is instructive to present an example environment in which embodiments of the present invention may be implemented.

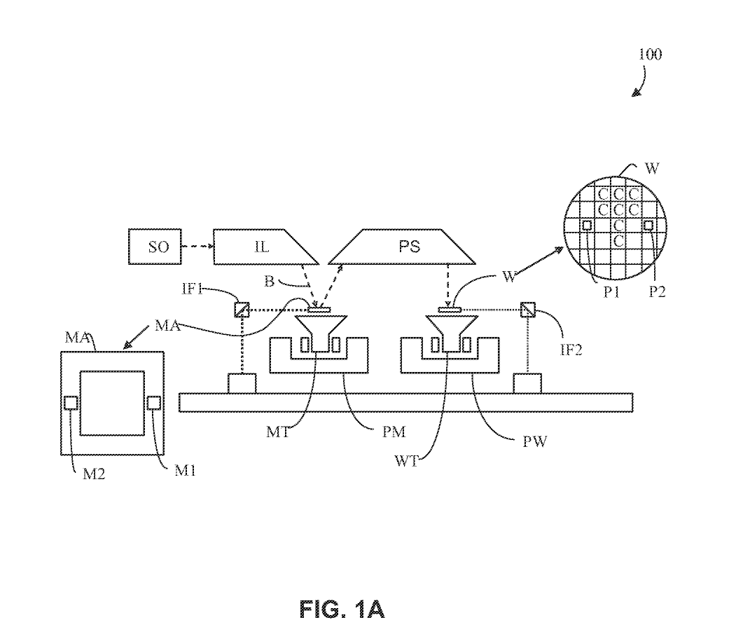

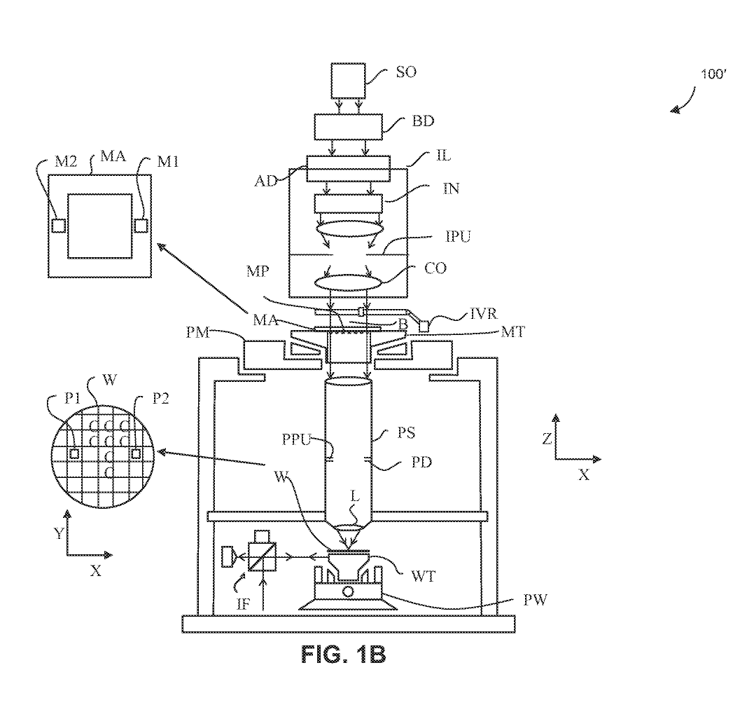

FIGS. 1A and 1B schematically depict lithographic apparatus 100 and lithographic apparatus 100′, respectively. Lithographic apparatus 100 and lithographic apparatus 100′ each include: an illumination system (illuminator) IL configured to condition a radiation beam B (e.g., DUV or EUV radiation); a support structure (e.g., a mask table) MT configured to support a patterning device (e.g., a mask, a reticle, or a dynamic patterning device) MA and connected to a first positioner PM configured to accurately position the patterning device MA; and a substrate table (e.g., a wafer table) WT configured to hold a substrate (e.g., a resist coated wafer) W and connected to a second positioner PW configured to accurately position the substrate W. Lithographic apparatuses 100 and 100′ also have a projection system PS configured to project a pattern imparted to the radiation beam B by patterning device MA onto a target portion (e.g., comprising one or more dies) C of the substrate W. In lithographic apparatus 100 the patterning device MA and the projection system PS is reflective, and in lithographic apparatus 100′ the patterning device MA and the projection system PS is transmissive.

The illumination system IL may include various types of optical components, such as refractive, reflective, magnetic, electromagnetic, electrostatic or other types of optical components, or any combination thereof, for directing, shaping, or controlling the radiation B.

The support structure MT holds the patterning device MA in a manner that depends on the orientation of the patterning device MA, the design of the lithographic apparatuses 100 and 100′, and other conditions, such as for example whether or not the patterning device MA is held in a vacuum environment. The support structure MT may use mechanical, vacuum, electrostatic or other clamping techniques to hold the patterning device MA. The support structure MT may be a frame or a table, for example, which may be fixed or movable, as required. The support structure MT may ensure that the patterning device is at a desired position, for example with respect to the projection system PS.

The term “patterning device” MA should be broadly interpreted as referring to any device that may be used to impart a radiation beam B with a pattern in its cross-section, such as to create a pattern in the target portion C of the substrate W. The pattern imparted to the radiation beam B may correspond to a particular functional layer in a device being created in the target portion C, such as an integrated circuit.

The patterning device MA may be transmissive (as in lithographic apparatus 100′ of FIG. 1B) or reflective (as in lithographic apparatus 100 of FIG. 1A). Examples of patterning devices MA include reticles, masks, programmable mirror arrays, and programmable LCD panels. Masks are well known in lithography, and include mask types such as binary, alternating phase shift, and attenuated phase shift, as well as various hybrid mask types. An example of a programmable mirror array employs a matrix arrangement of small mirrors, each of which may be individually tilted so as to reflect an incoming radiation beam in different directions. The tilted mirrors impart a pattern in the radiation beam B which is reflected by the mirror matrix.

The term “projection system” PS may encompass any type of projection system, including refractive, reflective, catadioptric, magnetic, electromagnetic and electrostatic optical systems, or any combination thereof, as appropriate for the exposure radiation being used, or for other factors, such as the use of an immersion liquid or the use of a vacuum. A vacuum environment may be used for EUV or electron beam radiation since other gases may absorb too much radiation or electrons. A vacuum environment may therefore be provided to the whole beam path with the aid of a vacuum wall and vacuum pumps.

Lithographic apparatus 100 and/or lithographic apparatus 100′ may be of a type having two (dual stage) or more substrate tables (and/or two or more mask tables) WT. In such “multiple stage” machines the additional substrate tables WT may be used in parallel, or preparatory steps may be carried out on one or more tables while one or more other substrate tables WT are being used for exposure. When the preparatory steps can be performed while one or more other substrate tables WT are being used for exposure, the preparatory steps are said to occur during an “in-line phase” because the preparatory steps are performed within the desired throughput of the lithographic apparatus 100 and/or lithographic apparatus 100′. In contrast, when the preparatory steps cannot be performed while one or more other substrate tables WT are being used for exposure, the preparatory steps are said to occur during an “off-line phase” because the preparatory steps cannot be performed within a desired throughput of lithographic apparatus 100 and/or lithographic apparatus 100′. As described in more detail herein, focus-positioning parameters of an exposure system (such as, for example projection system PS of lithographic apparatuses 100, 100′) may be determined in an off-line phase, an in-line phase, or a combination thereof.

Referring to FIGS. 1A and 1B, the illuminator IL receives a radiation beam from a radiation source SO. The source SO and the lithographic apparatuses 100, 100′ may be separate entities, for example when the source SO is an excimer laser. In such cases, the source SO is not considered to form part of the lithographic apparatuses 100 or 100′, and the radiation beam B passes from the source SO to the illuminator IL with the aid of a beam delivery system BD (FIG. 1B) comprising, for example, suitable directing mirrors and/or a beam expander. In other cases, the source SO may be an integral part of the lithographic apparatuses 100, 100′—for example when the source SO is a mercury lamp. The source SO and the illuminator IL, together with the beam delivery system BD, if required, may be referred to as a radiation system.

The illuminator IL may comprise an adjuster AD (FIG. 1B) for adjusting the angular intensity distribution of the radiation beam. Generally, at least the outer and/or inner radial extent (commonly referred to as σ-outer and σ-inner, respectively) of the intensity distribution in a pupil plane of the illuminator may be adjusted. In addition, the illuminator IL may comprise various other components (FIG. 1B), such as an integrator IN and a condenser CO. The illuminator IL may be used to condition the radiation beam B, to have a desired uniformity and intensity distribution in its cross section.

Referring to FIG. 1A, the radiation beam B is incident on the patterning device (e.g., mask) MA, which is held on the support structure (e.g., mask table) MT, and is patterned by the patterning device MA. In lithographic apparatus 100, the radiation beam B is reflected from the patterning device (e.g., mask) MA. After being reflected from the patterning device (e.g., mask) MA, the radiation beam B passes through the projection system PS, which focuses the radiation beam B onto a target portion C of the substrate W. With the aid of the second positioner PW and position sensor IF2 (e.g., an interferometric device, linear encoder or capacitive sensor), the substrate table WT may be moved accurately, e.g. so as to position different target portions C in the path of the radiation beam B. Similarly, the first positioner PM and another position sensor IF1 may be used to accurately position the patterning device (e.g., mask) MA with respect to the path of the radiation beam B. Patterning device (e.g., mask) MA and substrate W may be aligned using mask alignment marks M1, M2 and substrate alignment marks P1, P2.

Referring to FIG. 1B, the radiation beam B is incident on the patterning device (e.g., mask MA), which is held on the support structure (e.g., mask table MT), and is patterned by the patterning device. Having traversed the mask MA, the radiation beam B passes through the projection system PS, which focuses the beam onto a target portion C of the substrate W. With the aid of the second positioner PW and position sensor IF (e.g., an interferometric device, linear encoder or capacitive sensor), the substrate table WT can be moved accurately, e.g. so as to position different target portions C in the path of the radiation beam B. Similarly, the first positioner PM and another position sensor (which is not explicitly depicted in FIG. 1B) can be used to accurately position the mask MA with respect to the path of the radiation beam B, e.g., after mechanical retrieval from a mask library, or during a scan.

In general, movement of the mask table MT may be realized with the aid of a long-stroke module (coarse positioning) and a short-stroke module (fine positioning), which form part of the first positioner PM. Similarly, movement of the substrate table WT may be realized using a long-stroke module and a short-stroke module, which form part of the second positioner PW. In the case of a stepper (as opposed to a scanner) the mask table MT may be connected to a short-stroke actuator only, or may be fixed. Mask MA and substrate W may be aligned using mask alignment marks M1, M2 and substrate alignment marks P1, P2. Although the substrate alignment marks as illustrated occupy dedicated target portions, they may be located in spaces between target portions (known as scribe-lane alignment marks). Similarly, in situations in which more than one die is provided on the mask MA, the mask alignment marks may be located between the dies.

The lithographic apparatuses 100 and 100′ may be used in at least one of the following modes.

In step mode, the support structure (e.g., mask table) MT and the substrate table WT are kept essentially stationary, while an entire pattern imparted to the radiation beam B is projected onto a target portion C at one time (i.e., a single static exposure). The substrate table WT is then shifted in the X and/or Y direction so that a different target portion C may be exposed.

In scan mode, the support structure (e.g., mask table) MT and the substrate table WT are scanned synchronously while a pattern imparted to the radiation beam B is projected onto a target portion C (i.e., a single dynamic exposure). The velocity and direction of the substrate table WT relative to the support structure (e.g., mask table) MT may be determined by the (de-)magnification and image reversal characteristics of the projection system PS.

In another mode, the support structure (e.g., mask table) MT is kept substantially stationary holding a programmable patterning device, and the substrate table WT is moved or scanned while a pattern imparted to the radiation beam B is projected onto a target portion C. A pulsed radiation source SO may be employed and the programmable patterning device is updated as required after each movement of the substrate table WT or in between successive radiation pulses during a scan. This mode of operation may be readily applied to maskless lithography that utilizes programmable patterning device, such as a programmable mirror array of a type as referred to herein.

Combinations and/or variations on the described modes of use or entirely different modes of use may also be employed.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist), a metrology tool and/or an inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g., having a wavelength of or about 365, 248, 193, 157 or 126 nm) or extreme ultraviolet radiation (e.g., having a wavelength of 5 nm or above).

The term “lens,” where the context allows, may refer to any one or combination of various types of optical components, including refractive and reflective optical components.

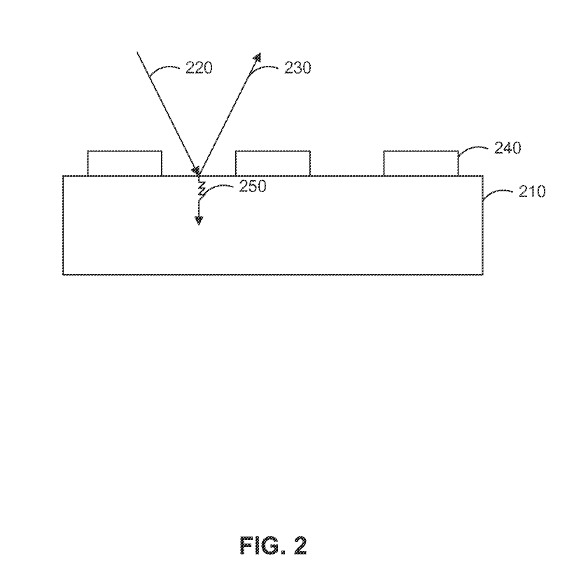

FIG. 2 provides a diagram of a reticle 210, with incident radiation 220 and reflected radiation 230. Pattern 240 on reticle 210 results in reflected radiation 230 being a patterned beam of radiation. The amount of reflected radiation 230 is less than the amount of incident radiation 220 due to absorbed radiation 250. Absorbed radiation 250 can result in heating and expansion of reticle 210, and therefore a distortion of pattern 240 which in turn translates into a distortion in the patterned beam of radiation. Typically, the heating and the resulting distortion are non-uniform across the surface of the reticle.

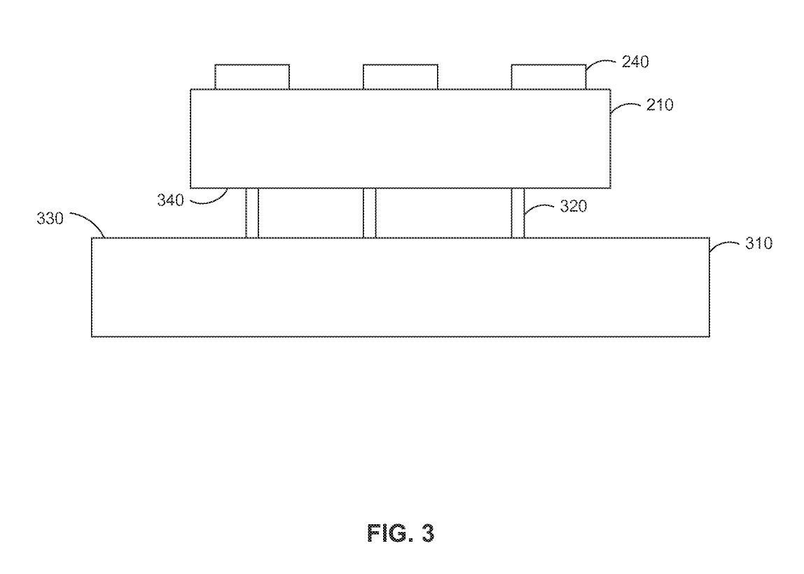

FIG. 3 provides a diagram of reticle 210 being held in place by a chuck 310. Chuck 310 is also commonly known in the art as a clamp. Contact between reticle 210 and chuck 310 is accomplished by the protrusions 320. Protrusions are also known as burls in the art. A plurality of protrusions 320, e.g., a two-dimensional array, are located across a surface 330 of chuck 310 to provide a distribution of contact points across a surface 340 of reticle 210. As discussed with reference to FIG. 2, heat transfer can result from absorbed radiation 250 in reticle 210 through to chuck 310 is available via conduction, convection and radiation. Thermal transfer by means of radiation can be very limited.

In one example, when reticle 210 is located in a vacuum, it is not desirable to use convection, i.e., convection would require substantial amounts of a moving gas that would compromise the vacuum environment. Further, because physical contact between chuck 310 and reticle 210 is via protrusions 320, the amount of thermal transfer by conduction via protrusions 320 is very limited.

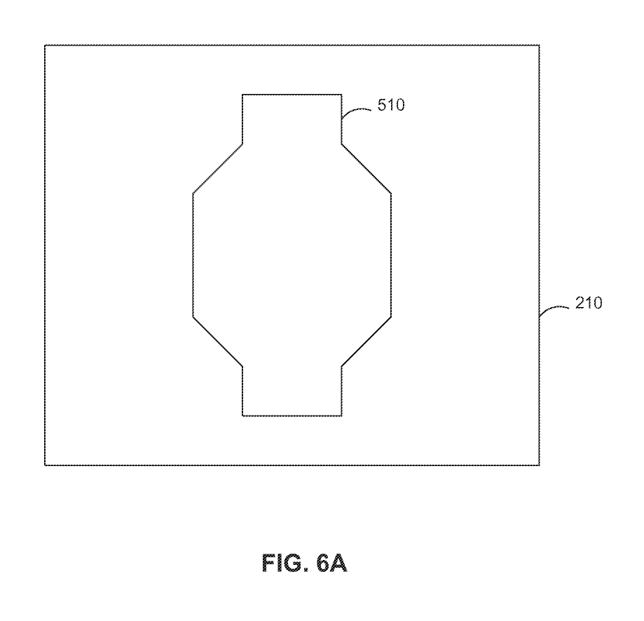

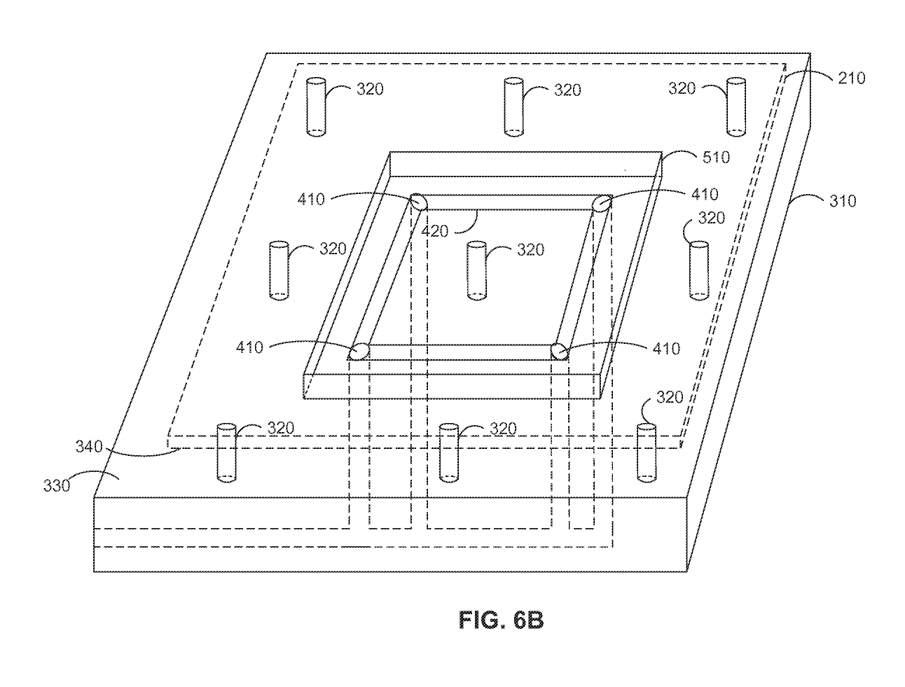

In one example, an additional channel of heat transfer by conduction can be provided through the use of a backfill gas that fills a cavity or interior volume. As shown in FIG. 6B, the gas is substantially constrained within a wall 510 which lies between opposing surface 340 of reticle 210 and surface 330 of chuck 310, i.e., the backside of reticle 210 and the frontside of chuck 310. Reticle 210, chuck 310 and backfill gas therefore form a thermal system with heat being generated within reticle 210, the heat then flows by conduction across to chuck 310 where it is thereby removed, as described below. In one example, in some situations a seal between the backside of reticle 210 and the frontside of claim 310 is imperfect, which can allow some of the backfill gas to leak into the surrounding vacuum. Thus, the backfill gas should be carefully selected so that any leakage does not introduce undesirable effects into equipment in the surrounding environment. An example of an appropriate backfill gas is hydrogen. Hydrogen at the appropriate pressure level affords both a reason thermal conduction path, while leaked hydrogen at a relatively low pressure does not introduce any undesirable effects into the equipment in the surrounding environment.

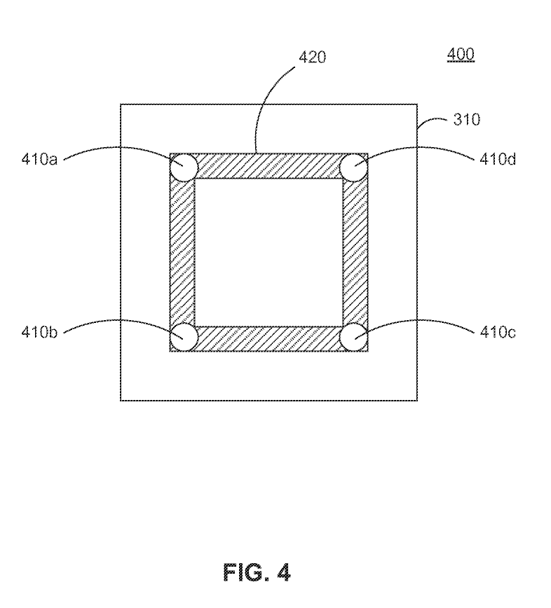

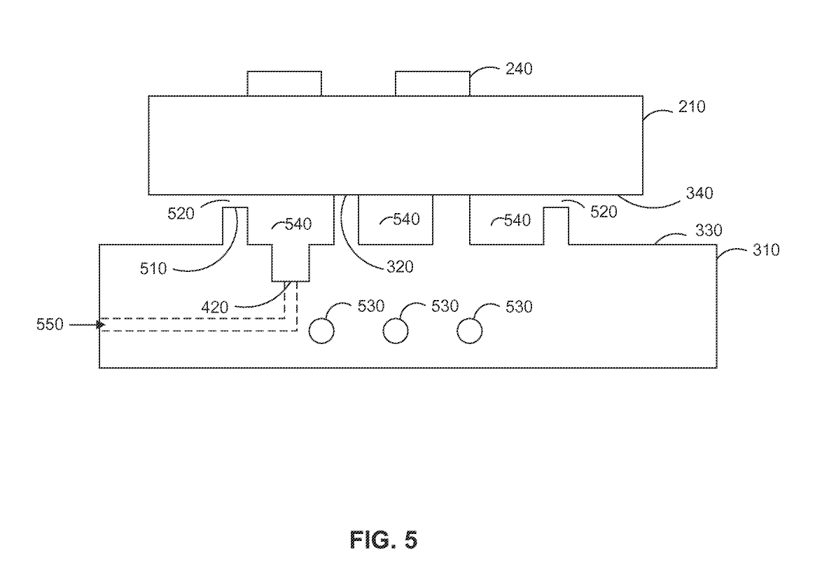

FIG. 4 illustrates a system 400. For example, system 400 can be used to allow backfill gas to be provided in the volume 540 formed by the space between wall 510, reticle 210 and chuck 310 (e.g., see FIGS. 5 and 6B). System 400 includes four backfill gas feed ports 410a, 410b, 410c, 410d through which backfill gas can be input from an external backfill gas source (not shown). The four backfill gas feed ports 410 are coupled to a distribution trench 420 that forms a perimeter around the internal volume in which high pressure backfill gas is desired to be maintained for thermal conduction purposes. Note that the description of four backfill gas feed ports 410 is purely for illustration only, and that any number of backfill gas feed ports (i.e., one or more) can be utilized. In one example, increasing the number of backfill gas feed ports improves the uniformity of the resulting backfill gas pressure at the expense of increasing the complexity of providing those additional backfill gas feed ports.

FIG. 5 illustrates a cross sectional view of the apparatus 400 depicted in FIG. 4. Backfill gas 550 is introduced into the volume 540 formed by the internal space between reticle 210 and chuck 310. Distribution trench 420 is shown on the inside of a wall 510 (e.g., flow restriction dam). Wall 510 can be used to maintain the backfill gas internal to the perimeter of the wall 510. In one example, wall 510 can include a small gap 520 between reticle 210 and chuck 310, e.g., because tolerances or fit is not as desired so that some separation forms between reticle 210 and chuck 310. If this separation occurs, a gap 520 can allow for leakage of the backfill gas to the outside environment. In one example, hydrogen is used as the backfill gas, with a high pressure of 1000 Pa being a typical pressure in the internal volume between reticle 210 and chuck 310. Outside the internal volume, leakage of hydrogen typically results in a low pressure of 3 Pa. Typical structural dimensions are a protrusion height of 10 μm, small gap dimension of 2.5 μm, and a trench width and depth of 0.5 mm and 0.3 mm respectively. These dimensions are provided by way of illustration, and not by way of limitation.

Also shown in FIG. 5, in one example chuck 310 can optionally contain one or more cooling channels 530 through which a cooling fluid passes in order to remove heat from chuck 310. In one example, a cooling fluid that passes through cooling channels 530 is water, although other cooling fluids could be used.

Returning to wall 510, in one example different thermal conduction profiles occur by changing the perimeter of wall 510. For example, uniform thermal conduction over the entire backside of reticle 210 can result by choosing the perimeter of wall 510 to correspond to the perimeter of reticle 210. However, as noted earlier, due to absorbed radiation 250, the center of reticle 210 can be relatively hot while the edges of reticle 210 can be relatively cool, with the consequence of non-uniform expansion of reticle 210. Thus, in this example it is desirable to reduce the thermal conduction at the edges of reticle 210 while maintaining the thermal conduction at the center of reticle 210. By doing so, the temperature variation across reticle 210, and the resulting expansion, becomes more uniform. Uniform reticle expansion is correctable, while non-uniform expansion is largely not. Thus, image placement errors such as distortion and overlay errors are reduced when the temperature variation across reticle 210 is made more uniform.

In an exemplary embodiment of the current invention, the perimeter of wall 510 (e.g., flow restriction dam) is reduced to achieve the desired temperature variation. For example, by reducing the perimeter of wall 510 so that it is within the interior of the perimeter of reticle 210, non-uniform thermal conduction over the backside of reticle 210 can be realized. Thus, by choosing the perimeter of wall 510 to be inside the edges of reticle 210, the normally cooler edges of reticle 210 can exhibit a lower thermal conduction and thus the temperature at the edges can increase. Since the normally hotter center of reticle 210 continues to receive a higher thermal conduction, the combined effect of the reduced perimeter of wall 510 is to provide a smaller temperature variation, a resulting smaller expansion variation and therefore reduced distortion and overlay errors.

FIGS. 6A and 6B illustrate an exemplary wall (e.g., flow restriction dam) configuration. By designing the perimeter of wall 510 to be smaller than, and therefore to fall inside, the edges of reticle 210, a non-uniform thermal conduction profile is achieved with a resulting reduction in the variation of temperature and therefore expansion across reticle 210.

FIG. 6A illustrates a plan view of wall 510 that falls within the edges of reticle 210. In this particular example, a 6-sided shape is illustrated, although any shape can be used that reduces the temperature variation of reticle 210.

FIG. 6B illustrates a perspective view of wall 510. In this figure, reticle 210 is shown resting on protrusions 320 and an inner space 540 is defined between opposing surfaces 330, 340 of reticle 210 and chuck 310. Backfill gas is introduced by way of feedports 410 and trench 420. Wall 510 or wall falls within the edges of reticle 210 and its perimeter is chosen to reduce the temperature variation of reticle 210. Wall 510 maintains a pressure of backfill gas in the inner space. As noted earlier, wall 510 can be any shape, consistent with the objective of reduce temperature variation across reticle 210. In FIG. 6B, a 4-sided shape is shown for illustration.

In a simulated demonstration of the current invention, the corrected overlay error was reduced from 2.0 nm to 1.3 nm. FIGS. 6A and 6B are is purely for illustrative purposes. Other perimeters and shapes of wall 510 can be designed based on the desired thermal conduction profile and temperature variation. As noted above, the desired thermal conduction profile is based on considerations such as reducing the expansion profile in response to the thermal profile of reticle 210.

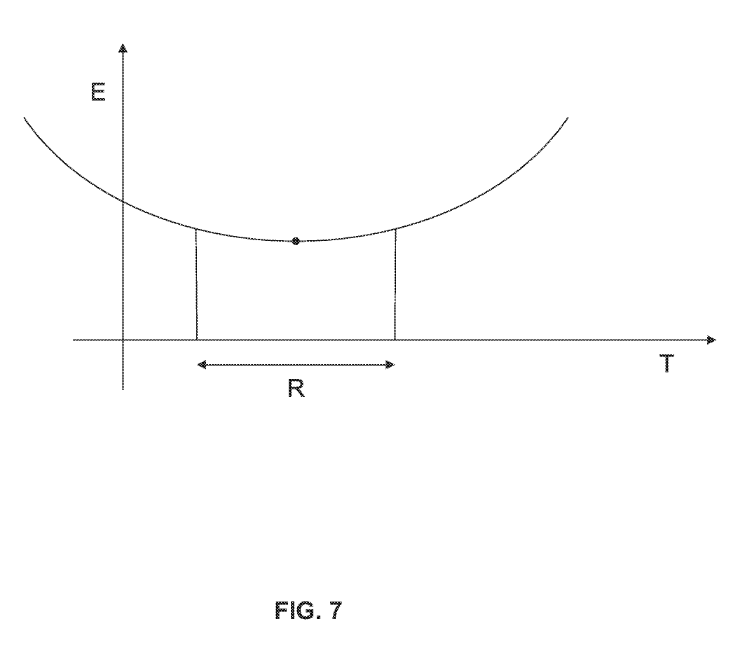

In a further exemplary embodiment, the relationship between expansion and temperature of the reticle material can be exploited. For example, FIG. 7 illustrates such a relationship, with the E-axis representing the expansion of the reticle material in response to the temperature of the reticle material shown on the T-axis. In the previous embodiments of the current invention, the design goal was to reduce the temperature variation across reticle 210 using a non-uniform thermal conduction profile created by a particular perimeter of wall 510. Since the ultimate objective is to reduce the expansion variation across reticle 210, an alternative design goal is to select a non-uniform thermal conduction profile that, when combined with the relevant material expansion-temperature characteristic, a reduced expansion variation results. In a particular embodiment, it is beneficial that the temperature variation range (illustrated as A in FIG. 7) of reticle 210 be centered on a minimum of the material expansion-temperature characteristic (see FIG. 7). By centering the operating temperature profile of reticle 210 on a minimum, the resulting expansion variation across reticle 210 is thereby substantially reduced.

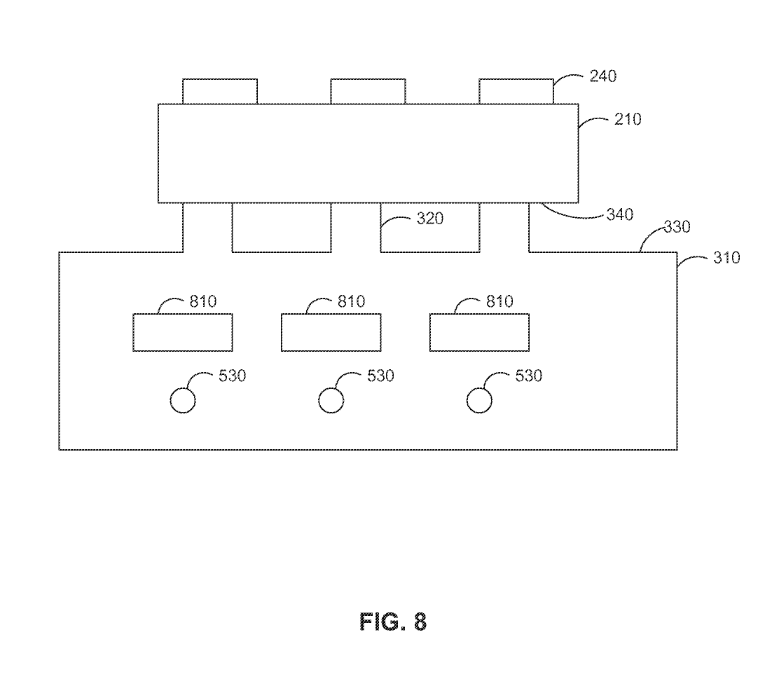

FIG. 8 illustrates a further embodiment of the current invention by showing a cross-sectional view of the use of selectively fillable cavities to produce a variable thermal conduction profile across reticle 210. Selectively fillable cavities 810 are shown within chuck 310 and are positioned between protrusions 320 and cooling channels 530. Three selectively fillable cavities 810 are shown in FIG. 8, although any number of selectively fillable cavities is within the spirit of the current invention. For example, a matrix of 4×4 selectively fillable cavities can be used. Selectively fillable cavities 810 function by each being selectively filled by a backfill gas. In the absence of being filled by a backfill gas, each cavity 810 contains a vacuum or low pressure backfill gas. By selectively filling cavities 810 with thermally conducting backfill gas, the thermal conduction path from the heat originating in reticle 210 to cooling channels 530 can be modulated. In particular, the modulation of the thermal conduction paths results in a modification of the temperature profile of reticle 210, and its resulting expansion profile. The number and pattern of selectively fillable cavities 810 can be designed based on considerations such as the resolution of thermal conduction selectivity across the area of reticle 210 and the complexity of providing the capability to selectively fill each cavity 810 with backfill gas. The backfill gas can be hydrogen or any other suitable gas that is consistent with the thermal conduction requirements and vacuum requirements of the environment. Note also, that this embodiment can be used in conjunction with the previous wall (e.g., flow restriction dam) embodiments, or by itself without the benefit of the previous wall embodiments.

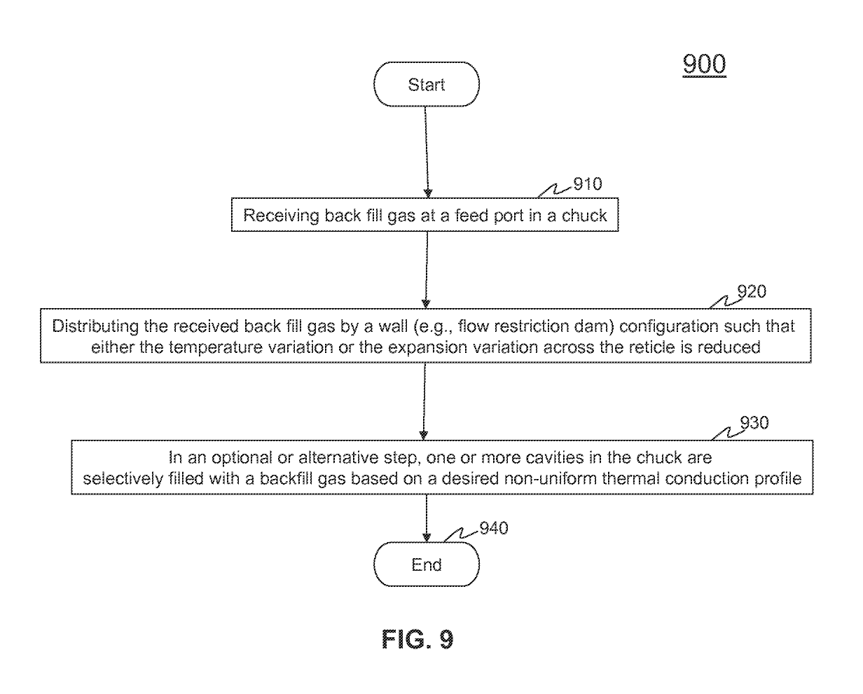

FIG. 9 provides a flowchart of an exemplary method 900 to provide a non-uniform thermal conduction profile across reticle 210, according to an embodiment of the present invention.

The process begins at step 910. In step 910, backfill gas is provided to a feed port in chuck 310.

In step 920, the received backfill gas is distributed by wall 510 (e.g., flow restriction dam) so that high pressure backfill gas coverage is less than across the entire reticle 210. As noted above, the design of the perimeter of wall 510 can address the goal of reducing temperature variation across reticle 210, or reducing expansion variation of the particular reticle material across reticle 210.

In an optional or alternative step 930, one or more cavities 810 in chuck 310 are selectively filled with a backfill gas based on a desired non-uniform thermal conduction profile. The backfill gas can be the same or different to that distributed in the volume (i.e., space) between reticle 210 and chuck 310.

At step 940, method 900 ends.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. An apparatus, comprising:
a chuck having a surface and outside edges configured to position a reticle having a surface and outside edges;
a plurality of protrusions extending from the surface of the chuck and configured to support the reticle; and
a wall between the surface of the chuck and the surface of the reticle and configured to define a space and to maintain a pressure of backfill gas in the space, wherein a perimeter of the wall is within the outside edges of the reticle.

2. The apparatus of claim 1, wherein the wall is further configured to permit a leakage of the backfill gas outside the space.

3. The apparatus of claim 1, wherein the wall and backfill gas are configured to reduce temperature variation of the reticle.

4. The apparatus of claim 1, wherein the backfill gas comprises hydrogen.

5. The apparatus of claim 1, further comprising:
a distribution trench coupled to the chuck and located within the perimeter of the wall, wherein the distribution trench is coupled to at least one feed port for input of the backfill gas.

6. The apparatus of claim 1, wherein the perimeter of the wall is configured to reduce the expansion variation of the reticle.

7. The apparatus of claim 1, wherein the chuck comprises a cooling channel configured to pass a cooling fluid.

8. The apparatus of claim 7, wherein the chuck comprises at least one cavity disposed within the chuck between the cooling channel and the protrusions, the cavity being configured to be selectively filled with a cavity backfill gas.

9. The apparatus of claim 1, wherein the chuck comprises a plurality of cavities within the chuck between the cooling channel and the protrusions, and wherein the plurality of cavities are configured to be selectively filled with backfill gas to reduce temperature variation of the reticle.

10. A method, comprising:
receiving backfill gas at a port in a chuck;
distributing the backfill gas to a space defined between the chuck, a reticle and a wall, wherein a perimeter of the wall is within the outside edges of the reticle; and
thermally contacting a heated region of the reticle with the backfill gas.

11. The method of claim 10, wherein the distributing further comprises permitting a leakage of the backfill gas.

12. The method of claim 10, wherein the distributing further comprises reducing a temperature variation of the reticle.

13. The method of claim 10, wherein the receiving further comprises receiving hydrogen.

14. The method of claim 10, wherein the receiving further comprises receiving the backfill gas at a port coupled to a trench in the chuck.

15. The method of claim 10, wherein the distributing further comprises reducing a variation of expansion of the reticle when in operation.

16. The method of claim 10, further comprising:
flowing cooling fluid through a cooling channel in the chuck.

17. The method of claim 10, further comprising:
filling a cavity with another backfill gas disposed within the chuck to remove heat from the reticle.

18. The method of claim 10, further comprising:
filling, with another backfill gas, a plurality of cavities disposed within the chuck corresponding to a temperature profile of the reticle to remove heat from the reticle.

19. A lithographic system, comprising:
a support device adapted to support a reticle that is capable of patterning a beam of radiation, wherein the support device comprises:
a chuck having a surface and outside edges configured to position a reticle having a surface and outside edges;
a plurality of protrusions extending from the surface of the chuck and configured to support the reticle; and
a wall between the surface of the chuck and the surface of the reticle and configured to define a space and to maintain a pressure of backfill gas in the space, wherein a perimeter of the wall is within the outside edges of the reticle; and
a projection system adapted to project the patterned beam onto a substrate.

20. The lithographic system of claim 19, wherein the wall is further configured to permit a leakage of the backfill gas outside the space.
